(19) United States
(12) Patent Application Publication
(10) Pub. No.: US 2026/0342182 A1
(43) Pub. Date: Oct. 29, 2026

(54) GUIDE JAW

(71) Applicant: Schaeffler Technologies AG & Co. KG, Herzogenaurach (DE)

(72) Inventors: Sebastian Reising, Alzenau (DE); Bernd Hammel, Altenstadt (DE); Vojtech Hirnich, Mücke-Atzenhain (DE)

(73) Assignee: Schaeffler Technologies AG & Co. KG, Herzogenaurach (DE)

(21) Appl. No.: 19/102,505

(22) PCT Filed: Aug. 2, 2023
(86) PCT No.: PCT/DE2023/100569

§ 371 Date: Feb. 10, 2025

(30) Foreign Application Priority Data
Aug. 10, 2022 (DE) 10 2022 120 095.7

(51) Int. Cl. H02K 15/043

(52) U.S. Cl. CPC H02K 15/0433

(57) ABSTRACT

A guide jaw serves to guide a plurality of wires (100) on a former (16) in order to produce wave windings (104), wherein the guide jaw (12, 14) has a number of first guide slots (23) that are arranged parallel to one another. To improve the guidance and to potentially be able to make a shape correction, it is proposed for the guide jaw (12, 14), in the region of the guide slots (23), to have a guide element (24) that is movable with respect to a first part (28) and has a corresponding number of second guide slots (32), wherein the guide element (24) is movable relative to the first part (28) of the guide jaw, while the wires (100) are held in the first and/or second guide slots (23, 32), such that the length of the wire guidance is increased compared to the length of the first guide slots (23) or second guide slots (32) alone. The present application also relates to a winding device equipped with corresponding guide jaws, and to a method for carrying out the process with straightening of any deformations of central wire sections that are shortened in the current state.

### CROSS-REFERENCE TO RELATED APPLICATIONS

This application is a U.S. national stage application under 35 U.S.C. § 371 that claims the benefit of priority under 35 U.S.C. § 365 of International Patent Application No. PCT/DE2023/100569, filed on Aug. 2, 2023, designating the United States of America, which in turn claims the benefit of priority under 35 U.S.C. § § 119, 365 of German Patent Application No. 102022120095.7, filed Aug. 10, 2022, the contents of which are relied upon and incorporated herein by reference in their entirety.

### FIELD OF THE DISCLOSURE

The disclosure relates to a guide jaw to guide a plurality of wires on a former in order to produce wave windings, according to the general term of claim 1, wherein the guide jaw has a number of first guide slots that are arranged parallel to one another. Another object of the present disclosure is a winding device with such guide jaws and a method for correcting shaping errors of the wave windings.

### BACKGROUND OF THE DISCLOSURE

A winding device with a guide jaw is, for example described in DE 10 2015 120 661 A1. In the process shown, it may happen that wires are not placed in the geometrically desired position on the former due to frictional forces and tensile forces acting on the wires. This leads to an asymmetry of the winding heads and shortened straight wire sections between the winding heads, which complicates the further processing of the wires and can also lead to considerable damage when pulling the winding into the slots of stators. Another known method is to reshape the wave windings in the area of the winding heads, but this is a very inefficient additional work step separate from the actual process.

The guide slots of the guide jaws cannot be extended arbitrarily, since if the wires are already deformed in the area of the straight sections before the first lowering, damage could already occur here.

The object of the present disclosure is to create guide jaws that better solve the problem of deformation between the winding heads and the straight wire sections.

### SUMMARY OF THE DISCLOSURE

According to the disclosure, the object is achieved by one of the types mentioned at the outset, in which the guide jaw has a guide element in the region of the guide slots that is movable to a first part and has a corresponding number of second guide jaws, wherein the guide element is movable relative to the first part of the guide jaw, while the wires are held in the first and/or second guide slots, such that the length of the wire guidance is increased compared to the length of the first guide slots or second guide slots alone.

The solution according to the disclosure offers the advantage that the guide jaw with a shortened guide length can first be placed on the wires and then, by moving the second guide slots in the direction of the winding heads, can not only increase the length of the guide and thus improve its stability, but also actively reshape the transition area between the straight sections and the winding heads without the need for a separate step separate from the actual process.

In a preferred embodiment of the disclosure, it is provided that the guide element with the second guide slots precedes the first guide slots and is movable perpendicular to the direction of extension of the wires relative to the first part of the guide jaw.

This configuration allows the second guide slots to be initially engaged in a more central area of the wires, which ensures that the wires have a straight path there so that the edges of the slots cannot collide with the wires when they are engaged, which in general have a rectangular cross-section. The second guide slots then move towards the winding heads so that the first guide slots can move into the more central area of the wires.

The sequence of motions of the second guide element can be effected by active adjusting elements, but it can also be achieved by corresponding guide elements between the guide element and the first part, which utilize the already provided feed motion of the guide jaw in the direction of the winding blade, which serves as a kind of stop. Thus, in a particularly preferred embodiment of the disclosure, a bevel is provided between the guide element and the first part of the guide jaw, which, when the guide jaw is lowered in the direction of the wires, guides the guide element in a direction towards the first part which has a component parallel to the first guide slots and a component perpendicular to the wires.

This results in the previously described sequence of motions, in which the second guide slots of the guide element first grip the wires in a relatively far inner area and are then moved in the direction of the winding heads with further advancement of the first part of the guide jaw, while the first guide slots move further forward and then also grip the wires, so that at the end of the sequence the first and second guide slots are aligned behind one another and offer a correspondingly greater guide length than conventional guide jaws.

In order to ensure a reverse sequence of motions when lifting the guide jaw, it is preferable for the motion of the guide element to take place against the restoring force of at least one spring element when the guide jaw is lowered.

In order to create space for tools in the middle, it can be advantageous for the first guide slots to be divided into two slot parts with a central recess.

While it is usually sufficient to straighten and guide the wires by means of a movable guide element, embodiments are also conceivable in which guide elements are provided on both sides of the first guide slots. Structurally, either a guide element is provided on one of the two slot parts or guide elements are provided on both slot parts.

As mentioned above, the previously described guide jaw can be integrated into the sequence of motions of a winding device known per se for winding flat wave windings with a wire feed for a plurality of wires, a sword-shaped winding template and guide jaws which can be lowered in the direction of the winding template for guiding the wires during the winding process, wherein the guide jaws of the type described above have, in the region of the guide slots, a guide element which is movable relative to a first part and has a corresponding number of second guide slots, wherein the guide element is movable parallel to the wires while the wires are held in the first and/or second guide slots, such that the length of the wire guidance is increased compared with the length of the first guide slots.

The advantage of the guide jaws according to the disclosure is particularly evident in such a winding device because the already structurally enabled lowering process of the guide jaw is now also used to reshape the wires and to extend the length of the guide over the entire straight wire area between the winding heads.

A further advantage in the process is that the surface of the former can serve as a stop for the guide jaw, so that the desired sequence of motions is possible without additional control elements.

This sequence of motions is then implemented in the winding device, such that the guide element with its second guide slots precedes the first guide slots and is movable perpendicular to the direction of extension of the wires relative to the first part of the guide jaw, wherein an inclination is provided between the guide element and the first part of the guide jaw, which, when the guide jaw is lowered onto the former, guides the guide element in a direction towards the first part, which has a component parallel to the first guide slots and a component perpendicular to the wires.

Another object of the present disclosure is a method for correcting deformations in the region of straight wire sections of wires in flat corrugated windings during winding on a former with guide jaws which guide the wires in the desired positions, wherein a guide element arranged movable relative to the guide jaw with second guide slots to first fixed guide slots is moved parallel to the wires while the wires are held in the first and/or second guide slots, such that the length of the wire guidance is increased compared to the length of the first guide slots, and the straight wire section of deformed wires is straightened over this length.

As mentioned above, the advantage of this method lies in the fact that it can be integrated into existing processes without any loss of time and also improves the process reliability of the known methods.

### BRIEF DESCRIPTION OF THE DRAWINGS

Further features, details and advantages of the disclosure result from the wording of the claims and from the exemplary embodiment described below with reference to the drawings. The drawings show:

FIG. 1 is a schematic representation of the problem of wire misalignment that exists in known winding methods;

FIG. 2 is a partial view of a winding device according to the disclosure; and

FIG. 3 is a side view of the winding device according to FIG. 2.

### DETAILED DESCRIPTION

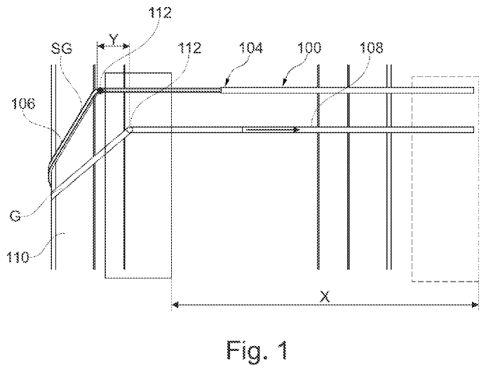

FIG. 1 schematically illustrates the problem of shape deviations of the wound wires 100 of a wave winding 104 wound on a flat former 110, which occurs when winding wave windings on a flat form. Due to frictional forces and tensile forces acting on the wires during the motion of a wire feed 114 by the distance X, a deformation takes place in the transition region between the winding heads 106 and the straight wire sections 108 located in between them. Depending on the direction of the force, an actual geometry IG can develop which deviates from a target geometry SG also shown in FIG. 1. When such a force is applied, a kink 112 of the wire 100 migrates by a distance Y in the direction of the form center, such that the central, straight wire section 108 is shortened compared to the target geometry. This can lead to considerable problems in wire handling during the further method of manufacturing a stator and in particular when pulling the wave winding 104 into the slots of the stator, wherein, additionally to the more difficult pulling in, there is also a risk of damage to the wires.

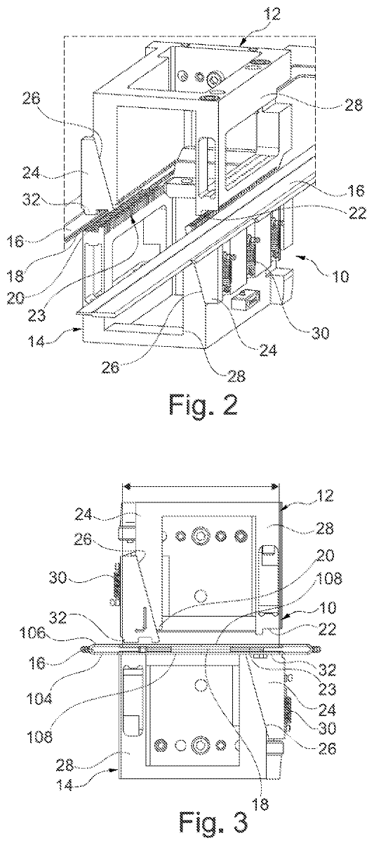

FIGS. 2 and 3 show parts of a winding device 10 with guide jaws 12, 14 on both sides of a flat former 16 which has a central recess 18. The guide jaws are also not designed to be continuous over the entire length of the central straight wire sections 108 (not shown in FIG. 2), but each have two slot parts 20, 22 at the ends of the straight wire sections 108 to be guided, which form first guide slots 23 for the wires of the wave winding. The guide jaws 12, 14 above and below the former 16 are otherwise identically designed, which is why their individual parts are also provided with identical reference symbols.

The guide jaws 12, 14 are each formed with a movable guide element 24 which is movably mounted along a guide inclination 26 on a first part 28 of the guide jaws. Compression springs 30 are provided to move the guide elements 24 in the direction of their rest position protruding beyond the guide slot parts 20, 22. At their end facing the wave winding or the former 16, the guide elements 24 have second guide slots 32 which lie in the same vertical plane as the first guide slots 23.

FIG. 2 shows an oblique view in which both guide jaws 12, 14 are in a rest position with the guide elements 24 extended. FIG. 3 shows this state with the former 12 above the former 16, while the guide jaw 14 below the former is in a guide position with the guide element 24 deflected. In this position, the middle straight wire sections of the wave winding 104 are guided both by the first guide slots 23 of the first parts 28 of the guide jaws 12, 14 and by the second guide slots 32 which are then aligned with them.

With reference to FIG. 3, the interaction of the two-part guide jaws 12, 14 with the former and the intermediate wave winding 104 is explained below.

The guide jaw 12 provided above the former 16 is not yet in engagement with the wave winding 104. It is easy to see the deflected guide element 24 with its second guide slots projecting beyond the first guide slots 23 in this position in the direction of the former 16.

After the straight wire sections 108 have been placed on the former 16, the guide jaw 12 is lowered and transferred to the state below the former 16, as shown in FIG. 3. During the motion, the second guide slots 32 initially engage between the central wire sections 108. Up to the point at which the guide element 24 reaches the former 16 and this subsequently acts as a stop, the first part 28 of the guide jaw 12 and the guide element 24 move together without their relative position to one another changing.

After reaching the former 16, which acts as a stop, the inclined guide 26 causes the guide element 24 to move outwards. The second guide slots 32 thus move outwards in engagement with the wires, whereby the wire is reshaped if necessary and the actual geometry is converted into the desired geometry. The fact that the second guide slots 32 initially engage further in the center also prevents the edges of the guide slots from colliding with the wires that deviate from the ideal shape, because the engagement takes place in an area in which the wire lies safely straight.

During the further feed motion of the guide jaw 12 with the guide element 24 in the vertical stop on the former, the latter is thus displaced exclusively outwards in the direction of the winding heads 106, while the first guide slots 23 engage in the central wire sections 108. The second guide slots 32 thereby give way to the first guide slots 23 laterally and, at the end of the feed process, are in alignment with the first guide slots 23 as an extension of the latter. In addition to the extended and thus improved guidance in the subsequent handling of the winding mat, as previously mentioned, subsequent corrections of the actual geometry in the direction of the target geometry are possible.

The disclosure is not limited to one of the embodiments described above, but can be modified in many ways.

All features and advantages resulting from the claims and the description, including design details, spatial arrangements and method steps, can be essential to the disclosure both individually and in various combinations.

### LIST OF REFERENCE SIGNS

10 Winding device
12 Guide jaw
14 Guide jaw
16 Former
18 Recess
20 Slot part
22 Slot part
23 First guide slots
24 Guide element
26 Inclined guide
28 First part of the guide jaw
30 Compression springs
32 Second guide slots
100 Wires
104 Wave winding
106 Winding heads
108 Straight wire sections
110 Former
112 Kink

1. A guide jaw for guiding a plurality of wires on a former for producing wave windings, comprising:
a plurality of first guide slots which are arranged parallel to one another; and
a guide element in the region of the plurality of first guide slots and having a corresponding plurality of second guide slots, wherein the guide element is movable relative to a first part of said guide jaw, while the wires are held in at least one of the plurality of first guide slots and the plurality of second guide slots, such that a length of wire guidance is increased compared to a length of the plurality of first guide slots in isolation or a length of the plurality of second guide slots in isolation.

2. The guide jaw of claim 1, wherein the guide element with the second guide slots precedes the first guide slots and is partially movable perpendicular to a direction of extension of the wires relative to the first part of said guide jaw

3. The guide jaw of claim 2, wherein between the guide element and the first part of said guide jaw an inclination is provided, which guides the guide element, when the guide jaw is lowered in the direction of the wires, in a direction relative to the first part which has a component parallel to the first guide slots and a component perpendicular to the wires.

4. The guide jaw of claim 3, wherein the motion of the guide element when lowering the guide jaw takes place against the restoring force of at least one spring element.

5. The guide jaw of claim 1, wherein the first guide slots are each divided into two slot parts with a central recess.

6. (canceled)

7. (canceled)

8. (canceled)

9. (canceled)

10. A method for correcting deformations in the region of straight wire sections of wires in flat wave windings during winding on a former with guide jaws which guide the wires, comprising the steps of:
moving, on a guide jaw that includes first guide slots, a guide element that includes second guide slots parallel to wires while the wires are held in the first guide slots and/or the second guide slots, such that a length of a wire guide provided by the first guide slots and the second guide slots is greater than a length that would be provided by the first guide slot in isolation or a length that would be provided the second guide slots in isolation; and
straightening a previously deformed straight wire section of at least one of the wires.

11. A winding device for winding flat wave windings, comprising:
a wire feed for feeding a plurality of wires;
a former; and
a pair of guide jaws, comprising:
a plurality of first guide slots which are arranged parallel to one another; and
a guide element in the region of the plurality of first guide slots and having a corresponding plurality of second guide slots, wherein the guide element is movable relative to a first part the pair of guide jaws while the wires are held in at least one of the plurality of first guide slots and the plurality of second guide slots, such that a length of wire guidance is increased compared to a length of the plurality of first guide slots in isolation or a length of the plurality of second guide slots in isolation.

12. The winding device of claim 11, wherein a surface of the former serves as a stop for at least one of the pair of guide jaws.

13. The winding device of claim 11, wherein the guide element with the second guide slots precedes the first guide slots and is movable with a directional component perpendicular to the direction of extension of the wires relative to the first part of the pair of guide jaws, and wherein an inclination is provided between the guide element and the first part, which, when the at least one of the pair of guide jaws is lowered onto the former, guides the guide element in a direction towards the first part which has a component parallel to the first guide slots and a component perpendicular to the wires.
